(19) United States
(12) Patent Application Publication
(10) Pub. No.: US 2025/0237561 A1
(43) Pub. Date: Jul. 24, 2025

(54) THIN FILM WIRELESS LABEL WITH INTEGRATED TEMPERATURE SENSOR

(71) Applicant: Reelables, Inc., Seattle, WA (US)

(72) Inventors: Oliver Peregrine Boswall-Perks, London (GB); Steven Andrew Swinbank, London (GB); Brian Grant Krejcarek, London (GB)

(21) Appl. No.: 18/416,666

(22) Filed: Jan. 18, 2024

Related U.S. Application Data
(60) Provisional application No. 63/438,845, filed on Jan. 13, 2023.

(51) Int. Cl. G01K 15/00; G01K 1/14

(52) U.S. Cl. CPC G01K 15/002; G01K 1/14; G01K 15/005

(57) ABSTRACT

An ultra-thin film wireless label can include a temperature sensor. The wireless label can be attached to an object, and the wireless label can be used as a temperature monitoring device. The wireless label can have a stacked structure laying the temperature sensor to have efficient thermal contact with the object, while being relatively insulated from the environment via an insulating layer. The temperature sensor can be calibrated, and the calibration parameters can be stored and later used to generate accurate temperature readings.

### CROSS-REFERENCE TO RELATED APPLICATIONS

This application claims the benefit of U.S. Provisional Patent Application No. 63/438,845, filed on Jan. 13, 2023, titled “THIN FILM WIRELESS LABEL WITH INTEGRATED TEMPERATURE SENSOR,” which is hereby incorporated in its entirety and should be considered a part of this disclosure.

### BACKGROUND

### Field

This invention relates generally to the field of thin film wireless labels and more particularly to ultrathin wireless labels with integrated temperature sensors.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Traditional methods of monitoring temperature of an object can benefit from advancements in the field of wireless label technology.

### SUMMARY

The appended claims may serve as a summary of this application.

### BRIEF DESCRIPTION OF THE DRAWINGS

These drawings and the associated description herein are provided to illustrate specific embodiments of the invention and are not intended to be limiting.

FIG. 1A illustrates a perspective view of the stacked layers of an example wireless label.

FIG. 1B illustrates a profile view of the wireless label attached to an object.

FIG. 2 illustrates an example reel of wireless labels.

FIG. 3 illustrates a setup for a calibration method using thermal baths.

FIG. 4 illustrates an environment in which a wireless label 100 can be used.

FIG. 5 illustrates empirical results showing approximately a linear relationship between supply voltage, raw temperature sensor readings, and the ambient temperature.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

Monitoring and logging temperature is a primary function of track and trace devices for cold chain logistics applications. In many use cases for pharmaceutical and critical perishable goods, very accurate temperature measurements with tolerances of +/−0.5° C. or better are required. This is critical since temperature-sensitive inventory, for example, vaccines, blood, biological reagents, chemicals, or live cultures, can spoil or degrade if stored or transported for even short periods outside of a specific temperature window.

The current state of the art for temperature sensing in a cold chain application includes temperature monitor devices (TMDs) that use microprocessor-based circuits, made on FR4 or flex polyamide circuit boards housed in rigid plastic enclosures. These devices typically employ a discrete temperature sensor, potentially with a digital interface to a microprocessor, or an analog interface in the case of a thermistor device. They can include a USB interface or a wireless interface such as NFC or Bluetooth.

Calibration is a necessary requirement for TMDs. Existing calibration methods can be cumbersome, time intensive, and a cost burden to manufacturing at any scale. For instance, for a class of TMDs, the fully assembled devices may need to undergo a process in which each device is stacked or arranged within an environmental chamber that exposes the device to known, pre-certified, calibration temperatures, such as 2° C., 5° C. or 8° C. This can involve manual effort loading the chamber, running the calibration sequence, unloading the chamber, unstacking, re-packing, and other cumbersome steps when performed for a large number of TMDs.

Since such environmental chambers typically circulate air and can have very low heat capacity, they can take a long time, known as the soak period, to calibrate devices. Since air movement can be restricted in many places around devices, a chamber can only allow for a limited number of devices, further adding reloading time and cost burdens to this calibration process. More significantly, the quality of calibration may also be affected by how the chamber is loaded. While +/−0.5° C. can be achieved, a growing number of applications demand even more accuracy in the calibration process, which can be difficult to achieve using the chamber-based calibration method.

In some cases, devices may incorporate pre-calibrated temperature sensors, but these are expensive, drastically increasing the cost of the device. Furthermore, the mechanical assembly, for example soldering or attachment to a PCB, can affect the calibration and accuracy of these devices, making the final device still uncalibrated. Furthermore, the housing of the device and how it is integrated with products or product packaging (e.g., cardboard boxes, Styrofoam, etc.) and whether the device is attached or incorporated on the inside or outside of the packaging can all be factors affecting the accuracy or deviation from a calibration point. Therefore, compared to pre-calibrated devices, performing calibration in the device's finished form can generally yield the best calibration results.

Other classes of TMDs can include semi-passive devices such as RFID or NFC-based TMDs and chemical indicators. The embodiments described herein can be applicable and beneficial to these TMDs as well. For chemical indicators, temperature changes facilitates a chemical reaction that typically results in color change on a sensor medium.

The described embodiments include a thin-film wireless label with an integrated temperature sensor and methods of calibration of the wireless label. The wireless label is included within a reel of similar wireless labels. The calibration process yields calibration parameters (e.g., calibration coefficients), which can be stored and used to derive accurate field temperatures when the wireless label is activated and used in the field.

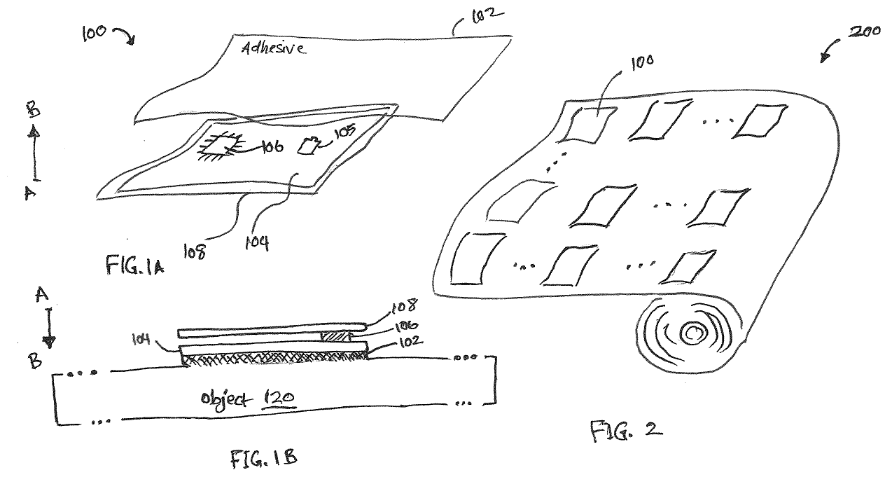

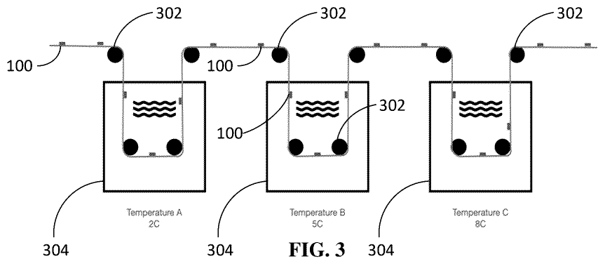

FIG. 1A illustrates an example wireless label 100 and FIG. 2 illustrates an example reel 200 of the wireless labels 100. The reel 200 can include a plurality of wireless labels 100 arranged in rows and columns. A user of the wireless label 100 can insert the reel 200 in a dispenser and/or a dispenser-printer combination device and print barcodes or other identifiers on a wireless label 100. In some embodiments, the dispenser-printer device can be a barcode printer. In some applications, the dispenser-printer can be augmented with near-field communication readers, scanners and the like to activate the wireless label 100 and/or to communicate with the wireless label 100.

The wireless label 100 can use an ultra-thin construction. The wireless label 100 can be attached to various objects, inside or outside of packaging via an ultrathin adhesive layer 102. The wireless label 100 can be a stack of ultrathin material, including for example, an interconnect layer 104, and an insulating layer 108. The insulating layer 108 can be fabricated from a foam-type material. The interconnect layer 104 can be an aluminum layer and can include a microcontroller 106 and an ultra-thin battery 105. The interconnect layer 104 can be fabricated from electrically and thermally conductive material, such as aluminum. The interconnect layer 104 can act as an electrically conductive substrate upon which electrical components can be fabricated. Consequently, the interconnect layer 104 can act as an interconnect between the electrical connections fabricated on the interconnect layer 104. For example, the microcontroller 106 and the battery 105 can be on the interconnect layer 104 and connected via the interconnect layer 104. Some examples of the wireless label 100 and details of those examples can be found in U.S. Pat. No. 10,964,197, entitled “LOW-POWER ELECTRONIC TAPE FOR TRACKING ITEMS,” the contents of which are hereby incorporated in their entirety and should be considered a part of this disclosure.

The microcontroller 106 can be programmed to provide various functionality for the wireless label 100. In some embodiments, the microcontroller 106 can be a system on chip (SOC) or a microcontroller unit (MCU). The microcontroller 100 can include a variety of internal subsystems. Examples of these systems can include, various wireless communication circuits, including Bluetooth and/or cellular components, analog to digital converters (ADCs), various sensors, including a temperature sensor, microprocessor systems for processing and/or generating sensor data and other subsystems.

The wireless label 100 can have two or more states. In an active state, the microcontroller 106 draws power from the battery 105 and performs selected or programmed functionality, for example, broadcasting data via a wireless network, such as a Bluetooth, WiFi or cellular. The broadcast data can include an identifier of the wireless label (e.g., a media access control or MAC address and sensor readings). For example, in the active state, the wireless label 100 can broadcast temperature readings from a temperature sensor. The wireless label 100 can also be in hibernation state, where the microcontroller 106 does not source any current from the battery 105. In some embodiments, the wireless label 100 can be cycled through the active and hibernation states. For example, some described embodiments, include activating a wireless label, which includes waking up the microprocessor 106 from hibernation, performing temperature calibration operations to generate calibration parameters and deactivating the wireless label 100. In this manner, a wireless label 100 can be activated at the factory to generate temperature calibration parameters. Once those parameters are stored, the wireless label 100 can be placed back in hibernation state until a user reactivates the wireless label 100. The calibration parameters can then be used to obtain accurate or near accurate temperature readings from the raw temperature sensor data broadcast from the wireless label 100. In other embodiments, the wireless label 100 can broadcast calibrated temperature data in the field, as opposed to raw temperature data.

The wireless label 100 has a stacked structure that provides advantages when the wireless label 100 is used as a TMD. For example, FIG. 1A illustrates a perspective view of the stacked layers of the wireless label 100. From direction A to B, the wireless label 100 includes an insulating layer 108, an interconnect layer 104 and an adhesive layer 102. Not all layers of the wireless label 100 are shown. The layers illustrated are chosen to describe the wireless label 100 in relation to temperature monitoring functionality of the label.

FIG. 1B illustrates a profile view of the wireless label 100 attached to an object 120. The wireless label 100 is attached to the object 120 via the adhesive layer 102. The adhesive layer 102 can be fabricated from thermally conductive material. In some embodiments, the adhesive layer 102 can be doped with metal particles to increase the efficiency of thermal contact between the object 120, the interconnect layer 104 and the microcontroller 106. However, a particle-filled adhesive layer is not a requirement in every embodiment, as the adhesive layer is thin-enough to allow for efficient thermal contact, even without the assisting particles. The interconnect layer 104 and the microcontroller 106 are thermally enclosed and/or insulated with the insulating layer 108. In this manner, the temperature sensor embedded in the microcontroller 106 experiences efficient thermal contact with the object 120, while being insulated from the environment of the object 120. While the embodiments will be described using the embedded temperature sensor of the microcontroller 106, this is not a requirement in every embodiment. Some wireless labels 100 can be fabricated with a discrete temperature sensor physically separate from the microcontroller 106.

The wireless label 100 can be manufactured where the microcontroller 106 is a silicon die bonded on a continuous moving film of aluminum-coated Polyethylene terephthalate (PET) substrate. In other words, the interconnect layer 104 can be constructed by coating an aluminum layer on a PET substrate. The embedded temperature sensor of the microcontroller 106 can be a relatively inexpensive method of providing a wireless label 100 with an on-board temperature sensor. However, such temperature sensors can be relatively inaccurate, without calibration.

An efficient method of performing calibration for the wireless labels 100 of the reel 200 can include exposing the labels to known temperatures, obtaining sensor temperature readings and generating temperature calibration parameters. The calibration parameters can be stored. When a wireless label 100 is activated and used in the field, the parameters can be used to convert the raw temperature sensor readings to a more accurate measure of the field temperature the wireless label 100 is experiencing.

FIG. 3 illustrates a setup for a calibration method using thermal baths. More specifically, the example shown in FIG. 3 illustrates the setup for a three-point calibration technique, using three thermal baths. However, fewer or more thermal baths can be used for calibration. Calibration in this context refers to a process of obtaining raw temperature readings from the temperature sensor of a wireless label in a known temperature environment of a thermal bath to generate calibration parameters, which can be used to later convert field temperature readings of a wireless label to accurate or near-accurate temperature readings.

In the example shown, the thermal baths are at 2° C., 5° C. and 8° C. The temperatures of the thermal baths can depend on the range of temperatures in which the wireless labels 100 are expected to be operating. Typically, for a three-point calibration, two values near the border of an expected range and one value near the middle of the range of expected operating temperatures are chosen to perform calibration. For example, if the wireless label 100 is expected to operate in 0 to 10° C., the calibration temperatures can be chosen as illustrated in the example shown in FIG. 3 (e.g., 2° C., 5° C. and 8° C.).

To perform calibration and obtain calibration parameters, a reel 200 of wireless labels 100 can be unrolled and moved in a web through a plurality of rollers 302. The rollers 302 catch, rotate and unwind the reel 200 to submerge the wireless labels 100 in the thermal baths 304. The rollers 302 in combination with motors can move the labels 100 from one calibration thermal bath 304 to the next. Before the labels are exposed to known temperatures, the labels are activated. The activated labels begin broadcasting various data, including their identifier and their respective temperature sensor readings. An antenna or receiver, placed in or near the thermal baths can be used to receive the broadcast data from each label as they are exposed to known temperatures of the thermal baths. When calibration is concluded, the labels are deactivated, and the reel 200 is rewound or rerolled again. The reel 200 can then be shipped to users. When the user activates a label 200, stored calibration parameters can be used to convert raw temperature readings to accurate or near-accurate temperatures.

Various fluids can be used in the thermal baths 304. Examples include water, distilled water, deionized water, a hydrofluoric solution, or other fluids. In some embodiments, wireless labels 100 can be coated in a waterproofing layer to prevent or minimize risk of corrosion.

An alternative method of calibration includes bringing the temperature sensors into contact with sets of thermodes at different temperatures, along with pre-calibrated platinum resistance thermistors alongside the microcontroller 106. In this method of calibration, the web of wireless labels 100 are moved beneath one or more sets of temperature-controlled thermode stations. Raw temperature measurements of the labels are captured, by for example, receiving Bluetooth packets from the labels with raw temperature measurement data. In addition high-accuracy measurement of the actual temperature experienced by the labels are also captured, using a pre-calibrated platinum resistance thermistor.

A variety of algorithms can be used to generate the calibration parameters from the raw temperature readings against the controlled temperatures of the thermal baths or thermodes. For example, one method includes obtaining raw temperatures and voltage ADC values from the submerged wireless labels 100 along with the known temperature values from high accuracy temperature probes in-situ in the thermal baths or on thermodes; cleaning the raw data to remove anomalies outside of allowed range in temperature and voltage (e.g. temperature reading anomalies caused when the label is first switched on, or the label hasn't fully adjusted to the ambient temperature of the fluid in the thermal bath or the thermode); running a multi-dimensional linear regression of the raw data and the known temperature using a least squares linear regression; fitting a linear model with coefficients that minimize the residual sum of squares between the observed targets in the dataset and the targets predicted by the linear approximation; obtaining calibration coefficients; and intercepting values from the linear regression.

The above-algorithm yields calibration coefficients, which can be stored in a server in the cloud and/or in the label. When the label is deployed in the field, the label can broadcast raw temperature readings, which can be converted to accurate temperature readings using the coefficients stored in the cloud, or alternatively, the label can perform the conversion and broadcast accurate temperature readings.

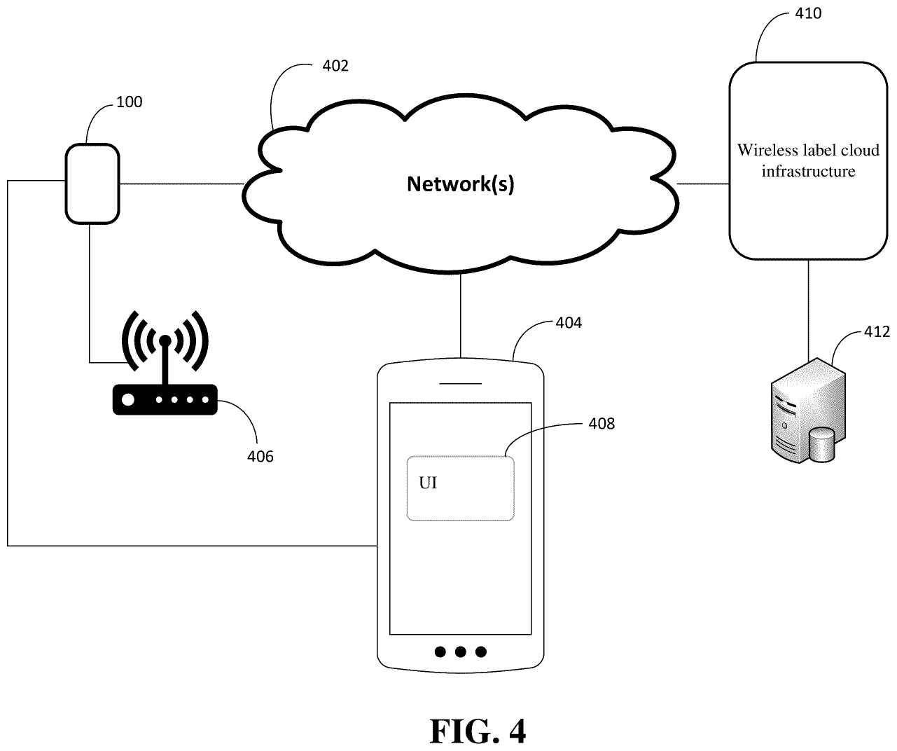

FIG. 4 illustrates an environment in which the wireless label 100 can be used. The wireless label 100 can be shipped to a customer as part of a reel of wireless labels 100. A user can activate a wireless label 100. The wireless label 100 can be in wireless communication via a network 402. The network 402 can include a variety of local and/or over-the-Internet networks, and can include subsidiary networks. For example, the wireless label 100 can be in wireless communication with a network via one or more gateways 406. The wireless label 100 can also be in wireless communication via a Bluetooth and/or cellular network with devices 404. In some embodiments, the wireless label 100 can be locally in wireless communication with devices 404, gateways 406, via Wifi, Bluetooth and/or cellular network. Those local networks can in turn be connected to the Internet. In some embodiments, the wireless label 100 can be in communication with a wireless label cloud infrastructure 410 via the network 402. The cloud infrastructure 410 can include one or more server 412 for providing various off-the-label processing and functionality for the wireless labels 100. For example, the infrastructure 410 can generate user interface (UI) 408 on devices 404. A user of the wireless 100 can access the various functionality of the wireless label 100 via the UI 408.

In some embodiments, the calibration parameters, such as calibration coefficients can be stored in the server 412 along with an identifier of a wireless label 100 to which the calibration parameters relate. An activated wireless label 100 can send temperature readings to the cloud infrastructure 410 along with the identifier of the wireless label 100 via the network 402. The cloud infrastructure 410 can access the stored calibration parameters for the wireless label 100, for example, via a look-up table (LUT). The stored calibration parameters can be used to generate accurate temperature readings from the received raw temperature readings of a wireless label 100. In other embodiments, the calibration parameters can be stored in the wireless label 100, where the wireless label 100 generates the accurate temperatures from the locally stored calibration parameters and transmits them, for example, to the UI 408. The accurate temperature readings whether provided via the cloud infrastructure 410 or the wireless label 100 can become the basis for various actions, such as generating notifications, alarms or any other functionality that depends on the temperature monitoring functionality of the wireless label 100.

In some embodiments, the wireless label 100 can utilize the temperature monitoring functionality to enhance the performance of the wireless label 100. For example, preserving battery life in an ultra-thin wireless label, such as the wireless label 100, can be advantageous. Furthermore, battery performance in colder environments deteriorates. The wireless label 100 can limit the rate of broadcasting of its data payload based on detecting a low temperature below a preselected threshold. The wireless label 100 can, therefore, conserve battery life and avoid interruptions in broadcasting in colder environments by reducing the load on the battery.

### Further Examples of Calibration

The microcontroller 106 can be a DA1453x and can contain a built-in temperature sensor with a single point calibration value present in OTP, determined during production. Accuracy of the calibration process can be related to the various aspects of the production environment. An example value of the obtained accuracy can be between −4 and +4° C.

In some embodiments, the labels can have two modes of temperature data transmission. The first is via Bluetooth Low Energy beacons, which can send periodic advertisement packets that include the instantaneous battery voltage as well as multi-sampled raw temperature sensor ADC values. The second is via connecting to a device 404 as a Bluetooth peripheral, wherein the device 404 can download historical battery levels and raw temperature ADC values.

The temperature sensor can have random sensitivity to its supply voltage, VBAT_LOW. Characterization measurements can show the following behavior: average=−0.2° C./V and Sigma=0.84° C./V. Calibration can also yield a temperature reading within a selected example target range (e.g., +0.5° C.), accounting for variation in supply voltage.

### Example Calibration Steps

Step 1—The relationship between ambient temperature, supply voltage and temperature sensor output are determined. For example, a Bluetooth chip can report the supply voltage (VBAT_LOW) and the ADC value of the built-in temperature sensor (T_ADC).

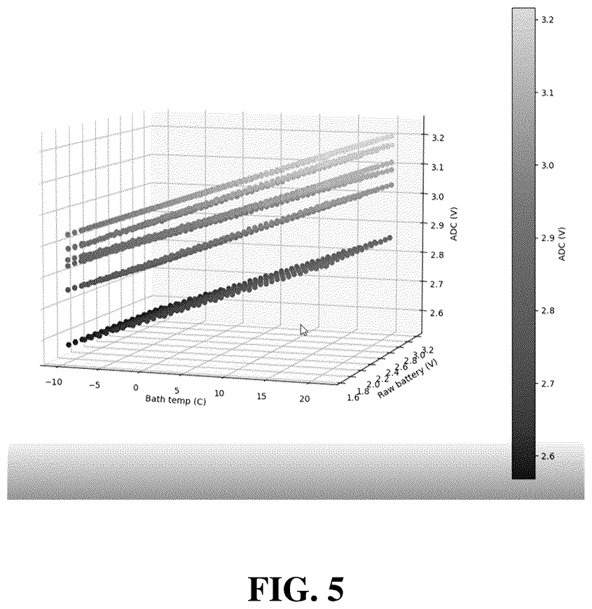

Using a Fluke Hart Scientific 7103 temperature bath (resolution 0.01° C. and Stability to ±0.015° C.) and silicone oil, data can be obtained for both VBAT_LOW and T_ADC for a sample of 6 wireless labels, across a temperature range of −10° C. to 50° C. (in 1° C. increments) and a voltage range of 1.1V to 3.2V (in 0.1V increments). The obtained data can show that the relationship between VBAT_LOW, T_ADC and the actual ambient temperature (T_AMBIENT) within the operational range of the labels can be approximated to be linear, with coefficients of determination (R-squared) values averaging 0.9999. FIG. 5 illustrates empirical results showing linear relationship between VBAT_LOW, T_ADC and T_AMBIENT for “6” test labels.

The linear relationship between VBAT_LOW, T_ADC and T_AMBIENT can also be shown to be unique to each label. Therefore, each label requires an individual calibration for both VBAT_LOW and T_ADC in order to achieve temperature accuracy within the target range.

### Step 2—Calibration Equation

Since the relationship between VBAT_LOW, T_ADC and T_AMBIENT can be linear, the relationship can be expressed as a linear equation. Equation (1) expresses an example linear relationship, which can be used to derive an ambient temperature experienced by a label (T_Label)

$${T}_{Label} = V {Bat}_{low} * {Bat}_{coef} + {T}_{ADC} * {T}_{ceof} + {T}_{intercept} \qquad Equation ( 1 )$$

To obtain the coefficient values (Bat_{coef} and T_{ceof}) and the intercept value (T_{intercept}) a two-point calibration of two temperatures and two supply voltages can be used. To reduce uncertainty and improve accuracy further, a third calibration point can be used to obtain a triple-point calibration method.

### Step 3—Calibration Methodology

During manufacturing each label can be exposed to two different temperatures (T_ambient), and at each temperature to two different supply voltages to obtain 4 datasets (LowTemp_Low Voltage, LowTemp_High Voltage, HighTemp_Low Voltage and HighTemp_HighVoltage). A linear regression can be performed on these datasets to determine the two calibration coefficients and the temperature intercept value. These coefficients and intercept values can be stored in the cloud for each label.

### Step 4—Calculating Temperature in Use

When temperature labels are used in production, the Bluetooth beacon can contain the T_ADC and VBAT_LOW value (oversampled to reduce error). This beacon can be received by for example, a mobile device or a cellular and/or wifi gateway, and the data can be sent up to the cloud infrastructure 410. Using the calibration coefficients and intercept values, the calibration calculation, Equation (1), is used to determine the ambient temperature that the label is experiencing.

### EXAMPLE APPLICATIONS

An additional benefit of the wireless label 100 includes integration in the logistics and supply chain tracking capabilities and other infrastructure. When shipments depart or arrive at facilities that comprise logistics supply chain routes, networked data gateways (e.g., Wifi and cellular) listen for signals from the labels. If the labels are temperature enabled, the gateway devices, connect to the labels via Bluetooth and download the raw temperature and battery level data, sending the data the cloud infrastructure for processing and transformation to accurate temperature values. These data gateways communicate to the cloud the timestamps transmitted by the labels, to determine whether data for a specific label has already been downloaded, and whether to carry out the download.

Another mode of operation is where the temperature tracking for specific labels can be wirelessly started and stopped, or the period of historical storage updated, by the network of data gateways via bi-directional Bluetooth connections, enabling data to be stored for periods of interest only, elongating the historical storage capacity as well as battery life of the labels.

When the battery level and raw temperature data arrive in the cloud infrastructure, they are transformed into accurate temperature values which are associated with the item the label is attached to and is tracking. The link between the item and the label is formed when the label is activated. Workflows, configured in the cloud, that define temperature threshold limits and rules on what action to take based on excursion from these thresholds are run. This can result in timely and automated alerts and notifications, as well as other outputs which can include generating custom-templated PDF reports, emailed to users or customers, machine-to-machine messaging via API webhooks or message busses and pub/sub systems, as well as triggering further workflows. The triggers can include temperature thresholds, temporal schedules, as well as geo-fence locations and specific zones within supply-chain journeys. An example would be a temperature data report for a shipment of vaccines, detailing the start time and end time, route of the journey, timeline of temperature levels, any excursions outside of the desired temperature range and a score indicating how normal this journey was compared to the customer's other journeys and benchmarked against other similar journeys by other customers.

In another aspect, the wireless labels can include a thin film Zn—Mn battery. At lower temperatures, batteries have reduced capabilities to deliver power to attached circuitry. Therefore, a method to conserve power is to rate-limit the beaconing of the device based on how quickly the temperature is changing. A steady temperature may only require hourly updates, conserving energy. At lower temperatures, typically below 0° C., the update rate is further reduced to 6 hours, for instance. But if the temperature is quickly rising, then the label is configured to more rapidly send beacon updates.

What is claimed is:

1. A method comprising:
unwinding a reel of wireless labels;
activating a wireless label of the reel from hibernation state, while the wireless label is still in the reel of wireless labels;
exposing the wireless label to one or more selected temperatures;
receiving temperature readings from a temperature sensor of the wireless label, when the wireless label is exposed to a selected temperature;
generating calibration parameters based on the received temperature readings and the selected temperatures; and
storing the calibration temperatures.

2. The method of claim 1 further comprising deactivating the wireless label and rewinding the reel of the wireless label.

3. The method of claim 1, wherein exposing the wireless label to a selected temperature comprises submerging the wireless label in one or more thermal baths, each thermal bath at a selected temperature.

4. The method of claim 1,
wherein the wireless label broadcasts data, the data comprising the temperature readings,
wherein exposing the wireless label to a selected temperature comprises submerging the wireless label in one or more thermal baths, each thermal bath at a selected temperature,
wherein receiving the temperature readings is via an antenna placed in the thermal baths.

5. The method of claim 1,
wherein the wireless label broadcasts data, the data comprising raw temperature readings,
wherein the calibration parameters are stored in a server,
wherein the method further comprises the server receiving the raw temperature readings and generating field temperatures based on the received temperature readings and the stored calibration parameters.

6. The method of claim 1,
wherein the wireless label broadcasts data, the data comprising raw temperature readings,
wherein the method further comprises receiving the raw temperature readings and generating field temperatures based on the received temperature readings and the stored calibration parameters.

7. The method of claim 1,
wherein the wireless label broadcasts data at a broadcasting rate, the data comprising raw temperature readings,
wherein the method further comprises receiving the raw temperature readings and generating field temperatures based on the received temperature readings and the stored calibration parameters,
wherein the wireless label is configured to reduce the broadcasting rate when the field temperatures are below a selected temperature.

8. The method of claim 1, wherein the calibration parameters are generated via linear regression.

9. The method of claim 1, wherein the wireless label comprises:
an adhesive, thermally conductive layer via which the wireless label is attachable to an object;
an interconnect layer comprising a microcontroller and a thin-film battery; and
an insulating layer thermally insulating the interconnect layer between the insulating layer and the adhesive layer.
